(19) United States
(12) Patent Application Publication
(10) Pub. No.: US 2011/0030555 A1
(43) Pub. Date: Feb. 10, 2011

(54) POLYCONDENSATION NETWORKS FOR GAS STORAGE

(75) Inventors: Gerhard Jonschker, Heppenheim (DE); Matthias Koch, Wiesbaden (DE); Joerg Pahnke, Darmstadt (DE); Mattias Schwab, Weinstrasse (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: MERCK PATENT GESELLSCHAFT MIT BESCHRANKTER HAFTUNG, Darmstadt (DE)

(21) Appl. No.: 12/919,225

(22) PCT Filed: Jan. 30, 2009
(86) PCT No.: PCT/EP09/00598

§ 371 Date: Aug. 25, 2010

(30) Foreign Application Priority Data
Feb. 26, 2008 (DE) 10 2008 011 189.9

(51) Int. Cl. B01D 53/02; C08G 75/00; C08G 61/12; B65D 85/00

(52) U.S. Cl. 95/90; 528/380; 528/397; 528/378; 206/6

(57) ABSTRACT

The invention relates to a polycondensation network built up from at least one aromatic, bifunctional Friedel-Crafts-active compound (main monomer) and at least one aromatic heterocompound (comonomer), and to the preparation and use thereof as gas storage material.

The invention relates to hypercrosslinked polycondensation networks built up from at least one main monomer having at least two aromatic chloro-methyl functions and from at least one aromatic heteroatom-containing co-monomer, and to the preparation and use thereof as gas storage material.

The storage of gases, in particular hydrogen, is of increasing economic importance. Materials which are able to adsorb the gases on a large surface allow the construction of gas tanks without high-pressure or cryotechnology. This is intended to provide the basis for conversion of vehicles powered today with liquid fuel to environmentally friendly or even environmentally neutral gaseous fuels. The gaseous fuels with the greatest existing and future economic and political potential have been identified as natural gas/methane and hydrogen.

The state of the art today in gas-powered vehicles is pressurised storage in steel bottles and to a small extent in composite bottles. The storage of natural gas in CNG (compressed natural gas) vehicles takes place at a pressure of 200 bar. In most prototypes of hydrogen-powered vehicles, pressurised storage systems with 350 bar or to a small extent cryogenic liquid hydrogen systems at −253° C. (20 K) are used.

As a future solution, pressurised systems for 700 bar which have a volume-based storage density comparable to liquid hydrogen are already being developed. Common features of these systems are still low volume efficiency and high weight, which restricts the range of the vehicles to about 350 km (CNG vehicles) or 250 km (hydrogen vehicles). Furthermore, the high energy expenditure for compression and in particular liquefaction represents a further disadvantage which reduces the possible ecological advantages of gas-powered vehicles. In addition, the tank design must take into account storage at very low temperatures (20 K) by means of extreme insulation. Since complete insulation cannot be achieved, a considerable leakage rate in the order of 1-2% per day must be expected in the case of such tanks. Taking into account the above-mentioned energetic and economic (infrastructure costs) aspects, pressurised storage is regarded as the most promising technology in the foreseeable future for the gaseous fuels natural gas (CNG) and later hydrogen.

An increase in the pressure level to above 200 bar in the case of CNG would only be imaginable with difficulty in technical and economic terms since an extensive infrastructure and rapidly growing vehicle stock of currently about 50,000 cars already exist in Germany now. Thus, potential solutions for increasing the storage capacity remain optimisation of the tank geometry (avoidance of individual bottles, structural tank in “cushion shape”) and an additional, supporting storage principle, such as adsorption.

This potential solution could also be applied to hydrogen, where even greater advantages would be expected than in the case of natural gas. The reason for this is the real gas behaviour of hydrogen (real gas factor Z>1), as a consequence of which the physical storage capacity only increases sub-proportionately with the pressure.

Chemical storage in metal-hydride storage media is already very well advanced. However, high temperatures arise during charging of the storage media and have to be dissipated in a short time during filling of the tank. Correspondingly high temperatures are necessary during discharge in order to expel the hydrogen from the hydrides. Both require the use of considerable amounts of energy for cooling/heating, which impairs the efficiency of the storage media. These disadvantages are caused by the thermodynamics of storage. In addition, the kinetics of hydride-based hydrogen storage media are poor, which increases the time needed for filling the tank and makes the provision of hydrogen during operation more difficult. Materials having faster kinetics are known (for example alanates), but are pyrophoric, which limits use in motor vehicles.

Besides conventional pressurised storage, essentially three concepts are currently under discussion for hydrogen storage: cryostorage, chemical storage media and adsorptive storage [see L. Zhou, Renew. Sust. Energ. Rev. 2005, 9, 395-408]. Cryostorage (liquid hydrogen) is technically complex and associated with high evaporation losses, while chemical storage using hydrides requires additional energy for decomposition of the hydride, which is frequently not available in the vehicle. An alternative is adsorptive storage, in which the gas is adsorbed in the pores of a nanoporous material. The density of the gas inside the pores is thus increased. In addition, desorption is associated with a self-cooling effect, which is advantageous for adsorptive cryostorage. However, the heat flows during adsorption and desorption are much smaller than in the case of hydrides and therefore do not represent a fundamental problem.

Various classes of material are basically suitable for gas or hydrogen storage owing to their high specific surface areas and their pronounced microporosity:
Active carbons (see Panella et al., Carbon 2005, 43, 2209-2214)
Carbon nanotubes (CNTs) (see Schimmel et al., Chem. Eur. J. 2003, 9, 4764-4770)
Zeolites and other silicate materials (see Jansen et al., Chem. Eur. J. 2007, 13, 3590-3595)
Metal-organic framework materials (MOFs) (see Zao et al., Science 2004, 306, 1012-1015)
Covalent-organic framework materials (COFs) (see El-Kaderi et al., Science 2007, 316, 268-272)
Polymeric intrinsic microporosity (PIM) (see Budd et al., Phys. Chem. Chem. Phys. 2007, 9, 1802-1808)
Hypercrosslinked polymers (HCPs) (see Budd et al., Phys. Chem. Chem. Phys. 2007, 9, 1802-1808)

Active carbons having optimised pore geometry achieve measurement results of 45.0 g of H₂/kg at 70 bar by physisorption of hydrogen (see Carbon 2005, 43, 2209-2214). For other highly porous carbon materials derived from carbide compounds (CDCs), storage capacities in the region of 30 g of H₂/kg or 24 g of H₂/kg at 1 bar are currently described (see Adv. Funct. Mater. 2006, 16, 2288-2293). For zeolites, values of 18.1 g of H₂/kg at 15 bar have been measured (see J. Alloys Compd. 2003, 356-357, 710-715). High gravimetric storage capacities of 75 g of H₂/kg for MOF-177 and 67 g of H₂/kg for IRMOF-20 in the pressure range from 70-80 bar have recently been published (see Zao et al., Science 2004, 306, 1012-1015).

Although the last-mentioned MOFs or metal-organic networks can significantly increase the storage capacity of a tank, they have the disadvantage of having only limited chemical resistance. Thus, many of these materials are extremely moisture-sensitive.

An alternative is highly microporous polymer networks, which can be prepared with little synthetic effort and have adequate chemical stability.

To date, highly porous polymer materials have been prepared by strong crosslinking (hypercrosslinking) of swollen, lightly crosslinked polymer particles, in particular based on polystyrene (see Davankov et al., Reactive & Functional Polymers 53 (2002) 193-203). In these so-called Davankov networks, a basic distinction is made between gelatinous and macroporous precursor polymers (see Sherrington, Chem. Commun. 1998, 2275-2286), which are prepared by suspension polymerisation in water and in the dry state are in the form of a finely divided powder. Owing to their low cross-linking agent content (less than 20 mol %), the gelatinous Davankov networks have low mechanical stability in the swollen state, which restricts their application. Although fairly high specific surface areas can be produced in these networks due to hypercrosslinking, it is not the total surface area alone that is crucial for gas storage purposes, but instead, in particular, the proportion emanating from pores in the (ultra) micro range. The storage capacity of these known materials is thus not yet adequate for commercial utilisation, which is why an increase in the absorption capacity for hydrogen represents an important research aim.

The object of the present invention was therefore to prepare a hypercross-linked polymer network which has a higher storage capacity for hydrogen than conventional materials with the same surface area (by the BET method) and the same pore-size distribution.

To date, the known hyperbranched polymer networks or polycondensation networks are predominantly based on materials which contain exclusively carbon and hydrogen and no heteroatoms.

Surprisingly, however, hypercrosslinked polymer networks (polycondensation networks) which, besides carbon and hydrogen, contain heteroatoms, such as oxygen, sulfur and nitrogen, have a higher storage capacity for hydrogen than the known materials comprising hydrocarbon compounds with the same surface area (by the BET method) and the same pore-size distribution. In addition, these polycondensation networks are robust, i.e. they are insensitive to moisture and are thermally stable. Furthermore, they can easily be prepared in a one-pot process.

The present invention thus relates to a polycondensation network built up from
at least one aromatic, bifunctional Friedel-Crafts-active compound (main monomer) and
at least one aromatic heterocompound (comonomer).

In accordance with the invention, “Friedel-Crafts-active compounds” are taken to mean compounds which react with aromatic systems under the catalytic action of a Lewis acid (such as, for example, FeCl₃) to give alkylated aromatic compounds.

The main monomers according to the invention must be at least bifunctional in order that intermolecular network formation can take place.

The main monomers employed in accordance with the invention are compounds of the general formula I

Y—Ar—Z (I)

where
Ar can be aromatic systems, such as benzene radicals, mono- or polysubstituted benzene derivative radicals, substituted or un-substituted biphenyl radicals, condensed aromatic ring systems, such as naphthalene radicals, anthracene radicals, fluorene radicals, phenanthrene radicals, tetracene radicals, pyrene radicals,
Y and Z, independently of one another, can be alkyl halide radicals, preferably alkyl chloride radicals, alcohol radicals, alkene radicals or radicals containing a keto group.
Y and Z are preferably equal to an alkyl chloride radical, preferably a methyl chloride radical.
Preference is given to the use of main monomers having at least two aromatic chloromethyl functions, preferably bis(chloromethyl) monomers. Most preference is given to 4,4′-bis(chloromethyl)-1,1′-biphenyl (BCMBP), whose homopolymer is described in the literature and has been selected as reference system here owing to the high hydrogen storage capacity. Particular preference is furthermore given to the use as main monomer of 1,4-bis-(chloromethyl)benzene, tris(chloromethyl)mesitylene and 9,10-bis(chloromethyl)anthracene.

It is additionally preferred to influence the porous properties of the polycondensation network through the use of sterically hindered comonomers and thus to achieve, for example, a widening of the network. The comonomers must contain aromatic units which are able to undergo Friedel-Crafts alkylation.

The comonomers employed are preferably compounds of the general formula II

Y-Het-Z (II)

where
Het can be heteroaromatic systems comprising five- and/or six-membered ring radicals which contain N, O and/or S as heteroatom,
Y and Z, independently of one another, can be H radicals, alkyl halide radicals, alcohol radicals, alkene radicals, radicals containing keto groups.
The radicals Y and Z are preferably equal to hydrogen. The comonomers thus preferably contain no halogenated alkyl groups, such as, for example, chloromethyl groups, in order thus to prevent homopolymerisation of these monomers and thus to ensure incorporation into the network of the main monomers.

Het preferably stands for a pyrrole radical, furan radical, oxazole radical, isoxazole radical, thiophene radical, thiazole radical, triazole radical, pyrazole radical, isothiazole radical, imidazole radical, pyrazine radical, pyridine radical, pyrimidine radical (1,3-diazine), pyridazine radical, purine radical, indole radical, quinoline radical, isoquinoline radical, acridine radical, quinazoline radical, purine radical, benzofuran radical, dibenzofuran radical, benzothiophene radical, carbazole radical, thianthrene radical, pteridine radical or phenazine radical.

The comonomers employed are particularly preferably dibenzofuran, dibenzothiophene and/or thianthrene.

The proportion of the aromatic comonomer is between 5 and 80 mol %, preferably between 10 and 50 mol %, based on the total molar amount of the components.

A widening of the polycondensation network according to the invention can also take place, for example, through spiro centres which are integrated into the chain. The spiro compound 9,9′-spirobifluorene has proven to be a fairly suitable polycondensation network here as comonomer (10 mol %) in combination with BCMBP (spec. surface area (BET)=1750 m²/g). However, the use of spiro compounds does not result in a significant increase in the storage capacities of the materials. The use of spiro compounds causes the formation of pores having a relatively large diameter, which have an unfavourable effect in hydrogen storage.

The central reaction for the preparation of polycondensation networks is, in accordance with the invention, the known Friedel-Crafts alkylation. The build-up and crosslinking of the polymer take place here in one step by means of a polycondensation reaction (see Cooper et al., Chem. Mater. 2007, 19, 2034-2048).

A similar Friedel-Crafts polycondensation has already been described earlier for fluorene in the presence of external electrophiles, such as methylene chloride or methoxyacetyl chloride (see Nystuen et al. J. Poly. Sci., Poly. Chem. Ed. 1985, 23, 1433-1444), or with 1,4-bis(chloromethyl)-benzene (see Chebny et al., JACS 2007, 129(27), 8458-8465), but at this time no investigation has taken place regarding the porosity and suitability of the resultant materials as gas storage media.
The materials obtained by polycondensation can also be referred to as precipitation polymers since the growing, strongly crosslinked chains undergo phase separation and precipitate from a certain degree of polymerisation.

The present invention thus furthermore relates to a process for the preparation of a polycondensation network, characterised by the fact that at least one aromatic, bifunctional, Friedel-Crafts-active compound (main monomer) is reacted with at least one aromatic heterocompound (comonomer).

In accordance with the invention, Lewis acids, such as aluminium chloride, iron chloride, zinc chloride or tin chloride, or protic acids (sulfuric acid, phosphoric acid) can be employed as reaction catalyst. Preference is given in accordance with the invention to iron(III) chloride or aluminium chloride, with iron (III) chloride being particularly preferred.

The Friedel-Crafts alkylation is thermally initiated and proceeds in accordance with the invention at temperatures of about 80° C. in the liquid phase. It is important to use a solvent which on the one hand dissolves (swells) the polymer formed to an adequate extent and on the other hand is inert to the Friedel-Crafts reaction (no aromatic compounds). 1,2-Dichloroethane is used in accordance with the invention as suitable solvent, but the use of hexane is also conceivable.

The polycondensation networks according to the invention (see Tables 1 and 2) are formed as finely divided powders, whose colour varies between brown and yellow shades.

The hypercrosslinked polycondensation networks according to the invention contain pores, in particular storage and transport pores, where storage pores (micropores) are defined as pores which have a diameter of 0.1 to 4 nm, preferably 0.5 nm to 3 nm. Transport pores (macropores) are defined as pores which have a diameter of 0.1 to 2 μm, preferably of 0.2 μm to 1 μm. The presence of storage and transport pores can be checked by sorption measurements, with the aid of which the absorption capacity of the polycondensation networks with respect to nitrogen at 77 K can be measured, more precisely in accordance with DIN 66131.

Porous substances are divided, according to the separation d between two opposite pore walls, into microporous (d<2.0 nm), mesoporous (2.0 nm<d<50.0 nm) and macroporous (d>50.0 nm) materials.
The size of the pores and of the pore connections can be controlled in accordance with the invention via the synthesis parameters. The latitude for adjustment of the pores here is significantly greater than in similar inorganic systems, such as, for example, the zeolites.
The proportion of micropore volumes in the polycondensation networks according to the invention is between 15 and 50%, preferably between 20 and 43%. Besides the micropores, mesopores also appear to be present in the material.

The specific surface area, as has been calculated in accordance with the Langmuir model, for the polycondensation networks according to the invention is between 1000 and 3500 m²/g. It is more preferably between 1200 and 2500 m²/g and most preferably between 1400 and 2000 m²/g, where the highest value is determined for polymer III (see Table 1) with 10 mol % of dibenzofuran. Polymer III, as preferred embodiment, also has, with 2.97 g/cm³, the highest pore volume of all polycondensation networks synthesised.

The present invention furthermore relates to a device for the uptake and/or storage and/or release of at least one gas, comprising the polycondensation network according to the invention.

The device according to the invention may comprise the following further components:
a container which accommodates the polycondensation network;
a feed or discharge aperture which allows at least one gas to enter or leave the device;
a gas-tight accommodation mechanism which is capable of keeping the gas under pressure inside the container.

The present invention furthermore relates to stationary, mobile or portable equipment which includes the device according to the invention.

The present invention furthermore relates to the use of the polycondensation networks according to the invention as gas storage material. In a preferred embodiment, the polycondensation networks according to the invention are employed for the storage of hydrogen and natural gas, preferably methane.

The following examples are intended to illustrate the present invention. However, they should in no way be regarded as limiting. All compounds or components which can be used in the preparations are either known and commercially available or can be synthesised by known methods. The temperatures indicated in the examples are always in ° C. It furthermore goes without saying that, both in the description and in the examples, the added amounts of the components in the compositions always add up to a total of 100%. Percentage data given should always be regarded in the given connection. However, they usually always relate to the weight of the part-amount or total amount indicated.

### EXAMPLES

1. Preparation of the Polycondensation Networks Based on 4,4′-bis-(chloromethyl-1,1′-biphenyl) as Main Monomer

1.1. Dibenzothiophene as Comonomer

### Example 1.1.1.

### 10.0 mol % of Comonomer

0.93 g (3.68 mmol) of 4,4′-bis(chloromethyl-1,1′-biphenyl) and 0.70 g (0.41 mmol) of dibenzothiophene (10.0 mol %, based on the total moles of monomer) are dissolved in 40.0 ml of dried 1,2-dichloroethane with stirring. The apparatus is rendered inert via an argon connection on the condenser, and 0.66 g (4.09 mmol) of anhydrous iron (III) chloride is added in a counterstream of argon. The flask contents are subsequently warmed to 80° C. The reaction is carried out under reflux for 18 h. The hypercrosslinked polymer is obtained after the reaction as a dark, finely divided precipitate. For work-up, the latter is firstly washed with water, during which the colour of the precipitate becomes paler. The precipitate is subsequently washed a number of times with relatively small portions of methanol until the methanol phase running off is colourless. The hypercrosslinked polymer is finally purified using tert-butyl methyl ether and then dried to constant weight at 80° C. in vacuo.

### Example 1.1.2.

### 25.0 mol % of Comonomer

0.80 g (3.20 mmol) of 4,4′-bis(chloromethyl-1,1′-biphenyl) and 0.20 g (1.07 mmol) of dibenzothiophene (25.0 mol %, based on the total moles of monomer) are dissolved in 40.0 ml of dried 1,2-dichloroethane with stirring. 0.69 g (4.27 mmol) of anhydrous iron (III) chloride is used for catalysis. The reaction is carried out analogously to the reaction conditions in Example 1.1.1.

1.2. Thianthrene as Comonomer

### Example 1.2.1.

### 10.0 mol % of Comonomer

0.91 g (3.63 mmol) of 4,4′-bis(chloromethyl-1,1′-biphenyl) and 0.09 g (0.42 mmol) of thianthrene (10.0 mol %, based on the total moles of monomer) are dissolved in 40.0 ml of dried 1,2-dichloroethane with stirring. 0.66 g (4.05 mmol) of anhydrous iron (III) chloride is used for catalysis. The reaction is carried out analogously to the reaction conditions in Example 1.1.1.

### Example 1.2.2

### 25.0 mol % of Comonomer

0.78 g (3.11 mmol) of 4,4′-bis(chloromethyl-1,1′-biphenyl) and 0.22 g (1.02 mmol) of thianthrene (25.0 mol %, based on the total moles of monomer) are dissolved in 40.0 ml of dried 1,2-dichloroethane with stirring. 0.67 g (4.13 mmol) of anhydrous iron (III) chloride is used for catalysis. The reaction is carried out analogously to the reaction conditions in Example 1.1.1.

1.3. Dibenzofuran as Comonomer

### Example 1.3.1

### 10.0 mol % of Comonomer

0.93 g (3.70 mmol) of 4,4′-bis(chloromethyl-1,1′-biphenyl) and 0.07 g (0.43 mmol) of dibenzofuran (10.0 mol %, based on the total moles of monomer) are dissolved in 40.0 ml of dried 1,2-dichloroethane with stirring. 0.67 g (4.13 mmol) of anhydrous iron (III) chloride is used for catalysis. The reaction is carried out analogously to the reaction conditions in Example 1.1.1.

### Example 1.3.2

### 25.0 mol % of Comonomer

0.82 g (3.26 mmol) of 4,4′-bis(chloromethyl-1,1′-biphenyl) and 0.18 g (1.07 mmol) of dibenzofuran (25.0 mol %, based on the total moles of monomer) are dissolved in 40.0 ml of dried 1,2-dichloroethane with stirring. 0.70 g (4.33 mmol) of anhydrous iron (III) chloride is used for catalysis. The reaction is carried out analogously to the reaction conditions in Example 1.1.1.

2. Preparation of Polycondensation Networks Based on tris(chloro-methyl)mesitylene as Main Monomer

2.1. Dibenzofuran as Comonomer

### Example 2.1.1

### 10.0 mol % of Comonomer

0.91 g (4.66 mmol) of tris(chloromethyl)mesitylene and 0.09 g (0.54 mmol) of dibenzofuran (10.0 mol %, based on the total moles of monomer) are dissolved in 40.0 ml of dried 1,2-dichloroethane with stirring. The apparatus is rendered inert via an argon connection on the condenser, and 0.84 g (5.20 mmol) of anhydrous iron (III) chloride is added in a counterstream of argon. The flask contents are subsequently warmed to 80° C. The reaction is carried out under reflux for 18 h. The hypercrosslinked polymer is obtained after the reaction as a dark, finely divided precipitate. For work-up, the latter is firstly washed with water, during which the colour of the precipitate becomes paler. The precipitate is subsequently washed a number of times with relatively small portions of methanol until the methanol phase running off is colourless. The hypercrosslinked polymer is finally purified using tert-butyl methyl ether and then dried to constant weight at 80° C. in vacuo.

3. Polycondensation Networks Based on 1,4-bis(chloromethyl)benzene as Main Monomer

3.1. Dibenzothiophene as Comonomer

### Example 3.1.1

### 25.0 mol % of Comonomer

0.74 g (4.23 mmol) of 1,4-bis(chloromethyl)benzene and 0.26 g (1.41 mmol) of dibenzothiophene (25.0 mol %, based on the total moles of monomer) are dissolved in 40.0 ml of dried 1,2-dichloroethane with stirring. The apparatus is rendered inert via an argon connection on the condenser, and 0.91 g (5.64 mmol) of anhydrous iron (III) chloride is added in a counterstream of argon. The flask contents are subsequently warmed to 80° C. The reaction is carried out under reflux for 18 h. The hypercrosslinked polymer is obtained after the reaction as a dark, finely divided precipitate. For work-up, the latter is firstly washed with water, during which the colour of the precipitate becomes paler. The precipitate is subsequently washed a number of times with relatively small portions of methanol until the methanol phase running off is colourless. The hypercrosslinked polymer is finally purified using tert-butyl methyl ether and then dried to constant weight at 80° C. in vacuo.

### Index of Figures

Table 1: Measurement values of nitrogen adsorption and hydrogen storage capacity (1.0 bar) for the systems comprising 10 mol % of comonomers I to V (drying temperature 110° C., 5 h)

I=100% of BCMBP (for comparison); II=fluorene (reference); Ill=dibenzofuran; IV=dibenzothiophene; V=thianthrene;

Table 2: Measurement values of nitrogen adsorption and hydrogen storage capacity (1.0 bar) for the systems comprising 25 mol % of comonomers VI to X (drying temperature 200° C., 5 h)

VI=100% of BCMBP (for comparison); VII=fluorene (reference); VIII=dibenzofuran; IX=dibenzothiophene; X=thianthrene;
It becomes clear that, in the case of thianthrene, the micropore proportion is higher compared with the other samples at the same time as a significantly lower spec. surface area. The comonomers according to the invention thus significantly improve the storage properties.

TABLE 1

| | I * | II | III | IV | V |
|---|---|---|---|---|---|
| Spec. surface area | 1680 | 1700 | 1800 | 1630 | 1440 |
| [m²/g] | | | | | |
| Pore volume [cm³/g] | 2.05 | 2.45 | 2.97 | 2.06 | 1.52 |
| Micropore volume | 0.41 | 0.45 | 0.46 | 0.44 | 0.40 |
| [cm³/g] | | | | | |
| Proportion of micro- | 20.0% | 18.4% | 15.5% | 21.4% | 26.3% |
| pore volumes | | | | | |
| Hydrogen storage | 13.7 | 15.3 | 14.6 | 13.7 | 14.0 |
| capacity (1.0 bar) | | | | | |
| [g of H₂/kg] | | | | | |

TABLE 2

| | VI * | VII | VIII | IX | X |
|---|---|---|---|---|---|
| Spec. surface area | 1680 | 1150 | 1190 | 1070 | 460 |
| [m²/g] | | | | | |
| Pore volume [cm³/g] | 2.05 | 1.07 | 1.03 | 0.87 | 0.31 |
| Micropore volume | 0.41 | 0.33 | 0.35 | 0.32 | 0.13 |
| [cm³/g] | | | | | |
| Proportion of micro- | 20.0% | 30.8% | 34.0% | 36.8% | 41.9% |
| pore volumes | | | | | |
| Hydrogen storage | 15.4 | 14.9 | 14.2 | 14.1 | 13.8 |
| capacity (1.0 bar) | | | | | |
| [g of H₂/kg] | | | | | |

* Reference system

1. Polycondensation network built up from
at least one aromatic, bifunctional Friedel-Crafts-active compound (main monomer) and
at least one aromatic heterocompound (comonomer).

2. Polycondensation network according to claim 1, characterised in that the main monomer is a compound of the general formula I
Y—Ar—Z (I)
where
Ar can be aromatic systems, such as benzene radicals, mono- or polysubstituted benzene derivative radicals, substituted or unsubstituted biphenyl radicals, condensed aromatic ring systems, such as naphthalene radicals, anthracene radicals, fluorene radicals, phenanthrene radicals, tetracene radicals, pyrene radicals,
Y and Z, independently of one another, can be alkyl halide radicals, preferably alkyl chloride radicals, alcohol radicals, alkene radicals or radicals containing keto groups.

3. Polycondensation network according to claim 1, characterised in that Y and Z are each equal to an alkyl chloride radical.

4. Polycondensation network according to claim 1, characterised in that the main monomer is 4,4′-bis(chloromethyl)-1,1′-biphenyl, 1,4-bis(chloromethyl)benzene, tris(chloromethyl)mesitylene or 9,10-bis(chloromethyl)anthracene.

5. Polycondensation network according to claim 1, characterised in that the comonomer is a compound of the general formula II
Y-Het-Z (II)
where
Het can be aromatic systems comprising five- and/or six-membered ring radicals which contain N, O and/or S as heteroatom,
Y and Z, independently of one another, can be H radicals, alkyl halide radicals, alcohol radicals, alkene radicals, radicals containing keto groups.

6. Polycondensation network according to claim 1, characterised in that Y and Z are equal to H.

7. Polycondensation network according to claim 5, characterised in that Het stands for a pyrrole radical, furan radical, oxazole radical, isoxazole radical, thiophene radical, thiazole radical, triazole radical, pyrazole radical, isothiazole radical, imidazole radical, pyrazine radical, pyridine radical, pyrimidine radical (1,3-diazine), pyridazine radical, purine radical, indole radical, quinoline radical, isoquinoline radical, acridine radical, quinazoline radical, purine radical, benzofuran radical, dibenzofuran radical, benzothiophene radical, carbazole radical, thianthrene radical, pteridine radical or phenazine radical.

8. Polycondensation network according to claim 1, characterised in that the comonomer is dibenzofuran, dibenzothiophene and/or thianthrene.

9. Polycondensation network according to claim 1, characterised in that the proportion of the comonomer is between 5 and 80 mol %, preferably between 10 and 50 mol %, based on the total molar amount of the components.

10. Polycondensation network according to claim 1, characterised in that it has a specific surface area (by the BET method) of 1000 to 3500 m²/g.

11. Polycondensation network according to claim 1, characterised in that the proportion of micropore volumes is between 15 and 50%, based on the total pore volume.

12. Process for the preparation of a polycondensation network, characterised in that at least one aromatic, bifunctional, Friedel-Crafts-active compound (main monomer) is reacted with at least one aromatic heterocompound (comonomer).

13. Process according to claim 12, characterised in that the polycondensation is carried out by means of catalysis by Lewis acids, such as FeCl₃, AlCl₃, ZnCl₂ or SnCl₄.

14. Process according to claim 12, characterised in that the main monomer employed is 4,4′-bis(chloromethyl)-1,1′-biphenyl, 1,4-bis(chloromethyl)benzene, tris(chloromethyl)mesitylene or 9,10-bis(chloromethyl)anthracene.

15. Process according to claim 12, characterised in that the comonomer employed is a comonomer containing at least one heteroatom, such as an S, O or N atom.

16. Process according to claim 12, characterised in that the comonomer employed is dibenzofuran, dibenzothiophene or thianthrene.

17. Process according to claim 12, characterised in that the comonomer is employed in an amount of 5 to 80 mol %, preferably 10 to 50 mol %, based on the total molar amount of the components.

18. Device for the uptake and/or storage and/or release of at least one gas, comprising a polycondensation network according to claim 1.

19. Device according to claim 18, characterised in that it additionally comprises a container which accommodates the polycondensation network; an aperture or outlet which enables the at least one gas to enter or leave the device; a gas-tight accommodation mechanism which is capable of keeping the gas under pressure inside the container.

20. Stationary, mobile and portable equipment comprising a device according to claim 18.

21. A process for storing gases comprising contacting one or more gases to be stored with a polycondensation networks according to claim 1 which acts as a storage medium for the gases.
